(19) United States
(12) Patent Application Publication
(10) Pub. No.: US 2008/0008250 A1
(43) Pub. Date: Jan. 10, 2008

(54) Video encoder

(75) Inventors: Hirofumi Mori, Koganei-shi (JP); Tatsunori Saito, Sagamihara-shi (JP); Yuji Kawashima, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/605,077

(22) Filed: Nov. 28, 2006

(30) Foreign Application Priority Data
Jul. 6, 2006 (JP) 2006-187168

(51) Int. Cl. H04N 11/04; H04N 7/12

(52) U.S. Cl. 375/240.24; 375/240.26

(57) ABSTRACT

A video encoder which encodes a video signal input in a frame unit, includes a determination unit configured to determine an insertion position of a refresh macro block to create first information indicating the insertion position of the refresh macro block, a division unit configured to divide a to-be-coded frame of the input video signal into a plurality of slices to cause the refresh macro block specified by the first information to become a head macro block to create second information indicating that a slice to which a target macro block belongs is changed, an intra-predictor to perform an intra prediction in the slice based on the second information to create a prediction image signal, and an encoding unit configured to encode the input video signal by use of the prediction image signal.

### CROSS-REFERENCE TO RELATED APPLICATIONS

This application is based upon and claims the benefit of priority from prior Japanese Patent Application No. 2006-187168, filed Jul. 6, 2006, the entire contents of which are incorporated herein by reference.

### BACKGROUND OF THE INVENTION

1. Field of the Invention

This invention relates to a video encoder.

2. Description of the Related Art

In an MPEG system which is a compression coding system for moving pictures, the coding process is performed by combining inter prediction, intra prediction, discrete cosine transform (DCT), variable-length coding and the like. Particularly, in the MPEG-4 system, intra macro blocks are periodically inserted into a coded frame in order to refresh propagation of errors occurred in a DCT process. Hereinafter, the macro block is referred to as an MB. When the MPEG-4 system is applied to a mobile radio terminal device and the like having a TV telephone function, intra MBs are periodically inserted into the coded frame in order to prevent an influence by errors caused in the radio transmission channel from propagating to a succeeding frame. The operation of periodically inserting the intra MBs into the coded frame is called a refresh operation and the intra MB is called a refresh MB. The refresh operation is generally performed by inserting intra MBs in a raster order.

In Jpn. Pat. Appln. KOKAI Publication No. 2001-169286, a video encoder is disclosed which monitors an error occurring in a transmission channel in the MPEG-4 system, corrects a determination condition to switch a prediction mode from an inter prediction mode to an intra prediction mode when the error rate becomes higher than one of a plurality of reference values prepared and performs the refresh operation in the intra prediction mode.

In the video encoding standard called H.264/AVC which is further developed from the MPEG system, an intra MB is predicted by use of pixels of a neighboring MB. Therefore, in H.264/AVC, if an error occurs in the neighboring MB, the error propagates to the intra MB, and as a result, the error cannot always be eliminated in the intra prediction process. Further, a method of gathering refresh MBs into one intra slice may be considered, but the overhead increases with each slice header when the method is applied. In H.264/AVC, it is possible to provide a method of predicting an intra MB without using the neighboring MB by excluding the inter MB from a reference MB by not using a pixel coded by inter prediction as a reference value (specifically, setting a flag of picture parameter set (PPS): constrained_intra_flag to “1”). However, with this method, since restriction is imposed on MBs other than the refresh MB, the coding efficiency is lowered.

### BRIEF SUMMARY OF THE INVENTION

An object of this invention is to prevent propagation of an error caused by the presence of a neighboring MB of a refresh MB and preventing the coding efficiency from being lowered.

According to a first aspect of the present invention, there is provided a video encoder which encodes a video signal input in a frame unit, comprising: a determination unit configured to determine an insertion position of a refresh macro block to create first information indicating the insertion position of the refresh macro block; a division unit configured to divide a to-be-coded frame of the input video signal into a plurality of slices to cause the refresh macro block specified by the first information to become a head macro block to create second information indicating that a slice to which a target macro block belongs is changed; an intra-predictor to perform an intra prediction in the slice based on the second information to create a prediction image signal; and an encoding unit configured to encode the input video signal by use of the prediction image signal.

According to a second aspect of the present invention, there is provided a video encoder which encodes a video signal input in a frame unit, comprising: a reference frame memory to store the input video signal as a reference image signal; a motion vector detector to detect a motion vector in a macro block unit in the reference image signal; an inter-predictor to perform an inter prediction by use of the motion vector and reference image signal to create an inter prediction image signal; a determination unit configured to determine an insertion position of a refresh macro block to create first information indicating the insertion position of the refresh macro block; a division unit configured to divide a to-be-coded frame of the input video signal into a plurality of slices to cause the refresh macro block specified by the first information to become a head macro block to create second information indicating that a slice to which a target macro block belongs is changed; an intra-predictor to perform an intra prediction in the slice based on the second information to create an intra prediction image signal; a selecting unit configured to select one prediction image signal from the intra prediction image signal and inter prediction image signal; and an encoding unit configured to encode the input video signal by use of the prediction image signal.

According to a third aspect of the present invention, there is provided a video encoder which encodes a video signal input in a frame unit, comprising: a calculation unit configured to calculate a difference between an input video signal and a prediction image signal to create a residual signal; a discrete cosine transform(DCT)/quantization unit configured to subject the residual signal to a DCT and quantization process to create a transform coefficient signal; an inverse cosine transform(IDCT)/inverse quantization unit configured to subject the transform coefficient signal to an IDCT and inverse quantization process to create a decoded signal of the residual signal; a decoding unit configured to add the decoded signal of the residual signal and the prediction image signal to create a decoded signal of the input video signal; a deblocking filter to filter the decoded signal of the input video signal; a reference frame memory to store a signal filtered by the deblocking filter as a reference image signal; a motion vector detector to detect a motion vector in the macro block unit in the reference image signal; an inter-predictor to perform an inter prediction by use of the motion vector and reference image signal to create an inter prediction image signal; a determination unit configured to determine an insertion position of a refresh macro block to create first information indicating the insertion position of the refresh macro block; a division unit configured to divide a to-be-coded frame of the input video signal into a plurality of slices to cause the refresh macro block specified by the first information to become a head macro block to create second information indicating that a slice to which a target macro block belongs is changed; an intra-predictor to perform an intra prediction in the slice based on the second information to create an intra prediction image signal; a selecting unit configured to select one prediction image signal from the intra prediction image signal and inter prediction image signal; and an encoder to encode the transform coefficient signal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a video encoder according to one embodiment of this invention.

FIG. 2 is a flowchart for illustrating the operation of the video encoder of FIG. 1.

FIG. 3 is a conceptual diagram showing the slice dividing process to set a refresh MB to a head MB.

FIG. 4 is a block diagram showing an example of a portable radio terminal device including a video encoder of FIG. 1.

### DETAILED DESCRIPTION OF THE INVENTION

An embodiment of this invention will be described with reference to the accompanying drawings.

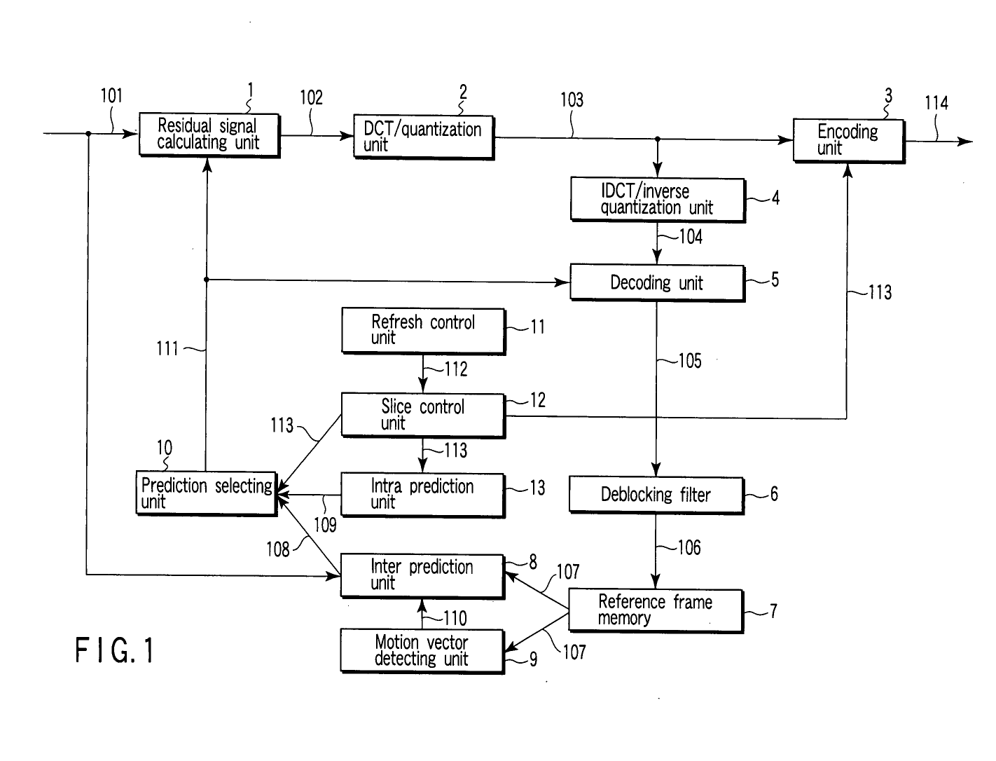

As shown in FIG. 1, a video encoder according to one embodiment of this invention includes a residual signal calculating unit 1, DCT/quantization unit 2, encoding unit 3, inverse discrete cosine transform(IDCT)/inverse quantization unit 4, decoding unit 5, deblocking filter 6, reference frame memory 7, inter prediction unit 8, motion vector detecting unit 9, prediction selecting unit 10, refresh control unit 11, slice control unit 12 and intra prediction unit 13.

In the present embodiment, propagation of an error occurring in a neighboring MB is prevented by performing a slice dividing process so as to set a refresh MB to a head MB. Further, in the present embodiment, a deteriorating the coding efficiency is prevented by performing the intra prediction process by using an inter MB other than the refresh MB as a reference MB. Since it is assumed that the present embodiment is applied to H.264/AVC, the intra prediction unit 13 can perform the intra prediction process in the block unit of 4×4 pixels, and particularly, the intra prediction process in the macro block unit of 16×16 pixels.

When a video signal 101 of an original image is input in the frame unit to the video encoder, a residual signal 102 between the video signal 101 and a prediction image signal 111 is generated by the residual signal calculating unit 1. One of an intra prediction signal 109 output from the intra prediction unit 13 and an inter prediction image signal 108 output from the inter prediction unit 8 is selected as a prediction image signal 111 by the prediction selecting unit 10. Prediction in a case where a pixel used for prediction belongs to the same frame as that of a to-be-coded pixel is called intra prediction and prediction in a case where the pixel belongs to a different frame is called inter prediction.

The DCT/quantization unit 2 subjects a residual signal 102 to DCT and quantization and outputs a quantized transform coefficient signal 103. The quantized transform coefficient signal 103 is input to the encoding unit 3 and IDCT/inverse quantization unit 4. The IDCT/inverse quantization unit 4 subjects the quantized transform coefficient signal 103 to inverse quantization and IDCT, generates a decoded signal 104 and outputs the same to the decoder unit 5.

The decoding unit 5 generates a decoded image signal 105 corresponding to the input video signal 101 by adding the decoded signal 104 of the residual signal 102 and the prediction image signal 111 and outputs the decoded image signal 105 to the deblocking filter 6. The deblocking filter 6 is a factor inherent to H.264/AVC and adaptively filters the decoded image signal 105 according to the rate of occurrence of distortion in order to reduce occurrence of block distortion. A decoded image signal 106 obtained after the filtering process is stored as a reference image signal in the reference frame memory 7. That is, the reference frame memory 7 sequentially stores image signals corresponding to a plurality of frames lying before and after the to-be-coded frame of the video signal 101 as reference image signals.

The motion vector detecting unit 9 reads out a reference image signal 107 from the reference frame memory 7 and detects a motion vector 110 in the macro block unit. In general, since a motion vector of a certain block (a target block) has strong correlation with respect to motion vectors of surrounding blocks, it can be predicted based on the surrounding blocks. A coding amount is reduced by encoding a difference vector between the motion vector of the target block and the prediction vector predicted based on the surrounding blocks. In H.264/AVC, the median of the motion vectors of the surrounding blocks is used as a prediction vector. Further, in H.264/AVC, variable block-size motion compensation and motion compensation for plural reference images are used.

The inter prediction unit 8 makes an inter prediction by subjecting the reference image signal to motion compensation by use of the motion vector 110 detected by the motion vector detecting unit 9 and generates a prediction image signal/evaluation value 108. The evaluation value expresses the degree of similarity between the reference image signal and the motion image signal. For example, the sum of square difference (SSD) and the sum of absolute difference (SAD) between the reference image signal and the motion image signal are generally used. The prediction image signal/evaluation value 108 is output to the prediction selecting unit 10.

The refresh control unit 11 determines the insertion position of the refresh MB and outputs the position information as refresh information 112 to the slice control unit 12. The slice control unit 12 makes slice division based on the refresh information 112 and outputs slice information 113 indicating that a slice to which the to-be-processed MB belongs is changed to the encoding unit 3, prediction selecting unit 10 and intra prediction unit 13. The intra prediction unit 13 makes an intra prediction in the slice to which the to-be-processed MB belongs by using a head MB as the refresh MB based on the slice information 113.

When receiving the slice information 113 from the slice control unit 12, the encoding unit 3 generates and encodes a slice header by use of a head MB of a new slice and outputs coded data 114 of the input video signal.

When detecting that the slice to which the to-be-processed MB belongs is changed based on the slice information 113, that is, the to-be-processed MB is a refresh MB, the prediction selecting unit 10 preferentially selects an intra prediction image signal 109 subjected to intra prediction by the intra prediction unit 13. If the to-be-processed MB is not a refresh MB, the prediction selecting unit 10 may compare an evaluation value 109 from the intra prediction unit 13 with an evaluation value 108 from the inter prediction unit 8 and select a candidate prediction image signal having a larger evaluation value.

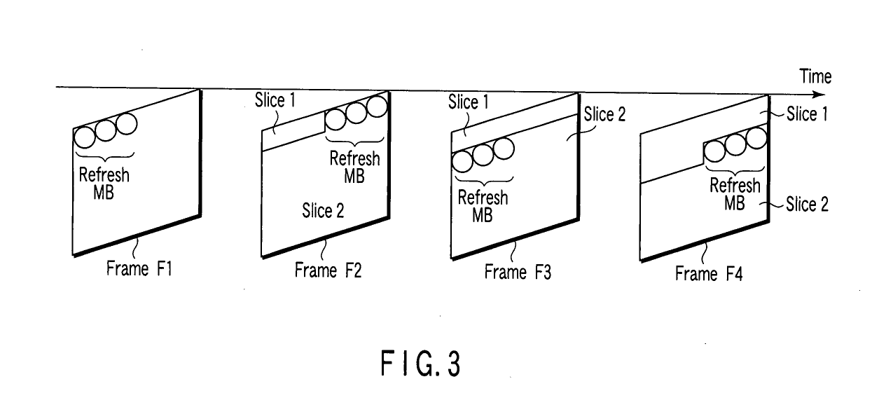

As described above, in the video encoder according to the present embodiment, attention is paid to the fact that an MB outside the slice cannot be referred to in intra prediction of H.264 and slice division is made to cause the refresh MB to become a head MB of each slice as shown in FIG. 3. That is, in FIG. 3, the refresh MB is used as the head MB of the slice in each of frames F1 to F4. By thus setting the refresh MB as the head MB of each slice, an intra MB which continues from the head MB of the slice can be set as a refresh MB, a refresh MB which does not refer to a neighboring MB can be easily inserted and propagation of an error caused by the presence of the neighboring MB can be prevented without using the flag: constrained_intra_flag. Further, deteriorating the coding efficiency can be prevented by making it possible to use an intra prediction in which the inter MB is referred to for an MB other than the refresh MB.

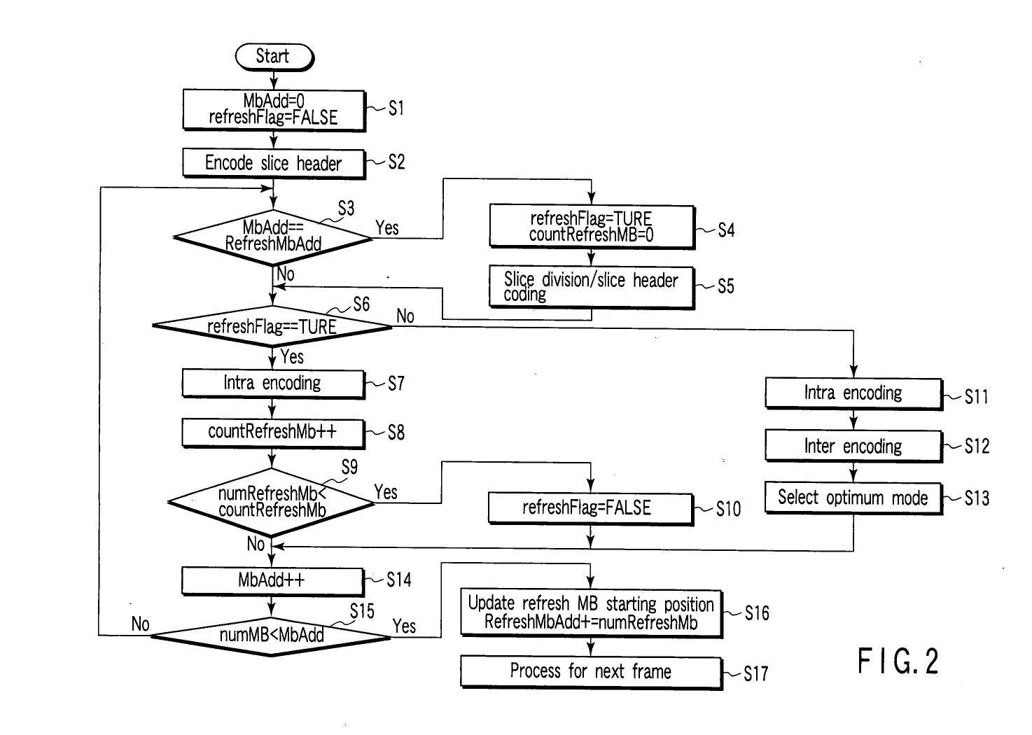

Next, a flow of a sequence of processes by the video encoder according to the present embodiment of this invention is explained in more detail with reference to the flowchart of FIG. 2.

First, the operation of initializing various variables and flags are performed (step S1). Specifically, “0” is set into a variable: MbAdd which indicates an address of a to-be-processed MB and “FALSE” (indicating that the MB is not a refresh MB) is set into a flag: refreshFlag which indicates whether the MB is a refresh MB or not.

Then, the encoding unit 3 generates and encodes a slice header and outputs coded data 114 of an input video signal 101(step S2). The slice header is always required for the head MB of the slice.

Next, whether the to-be-processed MB is a refresh start MB or not is determined (step S3). Specifically, if the variable: MbAdd is equal to a variable: RefreshMbAdd indicating an address of the refresh start MB (the determination result of S3 is “Yes”), the process proceeds to the step S4, and if not (the determination result of S3 is “No”), the process proceeds to the step S6.

In the step S4, “TRUE” (indicating that the MB is a refresh MB) is set into the flag: refreshFlag and “0” is set into a counter: countRefreshMB of the refresh MB. Then, slice division is made, the slice header is generated and encoded and the coded data 114 of the input video signal is output (step S5). After this, whether the to-be-processed MB is a refresh MB or not is determined (step S6). Specifically, the state of the flag: refreshFlag is detected and if refreshFlag is “TRUE” (the determination result of S6 is “Yes”), the process proceeds to the step S7, and if not (the determination result of S6 is “No”), the process proceeds to the step S11.

In the step S7, an intra prediction is made by the intra prediction unit 13 with respect to an MB corresponding to the to-be-processed MB which is determined to be a refresh MB in the step S6. Next, the value of the counter: countRefreshMB is incremented by one (step S8). Then, whether a variable: numRefreshMb indicating the number of refresh MBs in a slice is smaller than the value of the counter: countRefreshMb or not is determined (step S9). Specifically, if the variable: numRefreshMb is smaller than the value of the counter: countRefreshMb (the determination result of S9 is “Yes”), the process proceeds to the step S10, and if not (the determination result of S9 is “No”), the process proceeds to the step S14.

In the step S10, “FALSE” is set into the flag: refreshFlag and the process proceeds to the step S14. That is, the loop of the refresh process (step S3→step S6→step S9→step S14→step S15→step S3) is repeated by the preset number: numRefreshMb of refresh MBs and then the flag: refreshFlag is set to “FALSE” in the present step.

In the step S11, the intra prediction unit 13 makes an intra prediction to generate an intra prediction image signal 109. Next, the inter prediction unit 8 makes an inter prediction to generate an inter prediction image signal 108 (step S12). Then, the prediction selecting unit 10 selects one of the intra prediction image signal 109 created in the step S11 and the inter prediction image signal 108 generated in the step S12 as a prediction image signal 111 and the process proceeds to the step S14 (step S13).

In the step S14, the variable: MbAdd is incremented by one in order to change the to-be-processed MB to a next MB. Then, whether the variable: numMB indicating the number of MBs in the frame is smaller than the variable: MbAdd or not is determined (step S15). Specifically, if the variable: numMB is smaller than the variable: MbAdd (the determination result of S15 is “Yes”), the process proceeds to the step S16, and if not (the determination result of S15 is “No”), the process returns to the step S3. That is, the above process (steps S3 to S14) is repeatedly performed for all of the MBs of the processing unit (one frame).

In the step S16, the starting position of the refresh MB is updated. Specifically, the updating process is performed by adding the variable: numRefreshMB to a variable: RefreshMBAdd. When a sequence of processes is thus ended, the same process is performed for a next frame (step S17).

As described above, in the video encoder according to the present embodiment of this invention, the refresh control unit 11 determines an insertion position of the refresh MB and deals with the position information as refresh information 112, and the slice control unit 12 makes slice division to cause the refresh MB to become a head MB of each slice based on the refresh information 112 and generates slice information 113 indicating a slice to which a to-be-processed MB belongs is changed. Further, the intra prediction unit 13 makes an intra prediction in a slice to which a to-be-processed MB belongs based on the slice information 113. Also, when it is detected that a to-be-processed MB is a refresh MB based on the slice information 113, the prediction selecting unit 10 preferentially selects an intra prediction.

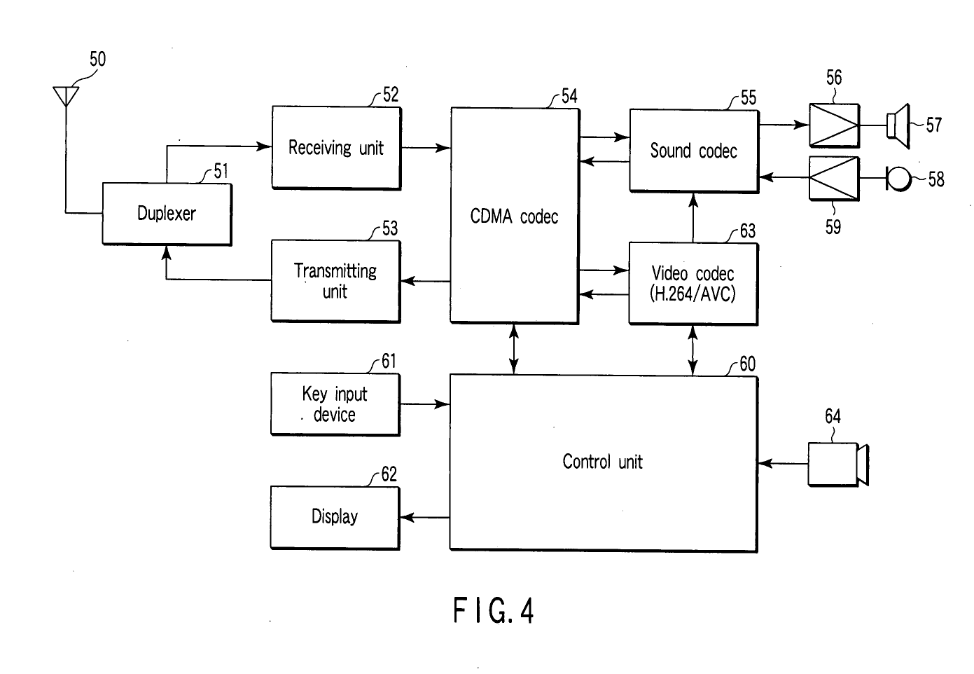

FIG. 4 shows a portable radio terminal such as a cellular phone which is an applied example of the present invention. Upon reception, an antenna 50 receives a radio frequency (RF) signal transmitted by a base station included in a carrier communication network (not shown). The received signal is input to a receiving unit 52 via a duplexer 51. The receiving unit 52 performs processing such as amplification, frequency conversion (down conversion), and analog to digital conversion on the received signal to generate an intermediate frequency (IF) signal. A received baseband signal is input to a code division multiple access (CDMA) codec 54. The code division multiple access codec 54 subjects the signal to orthogonal demodulation and despreading to obtain received data. If the received RF signal is a voice signal, a voice codec 55 decompresses the received data in accordance with a predetermined voice decoding system. The voice codec 55 further performs a digital to analog conversion to decode the data into an analog signal. The analog signal is supplied to a speaker 57 via a power amplifier 56. The speaker 57 then outputs a sound.

Upon transmission, a microphone 58 detects a sound made by a user as a sound signal. A preamplifier 59 amplifies the sound signal. Then, the sound codec 55 digitalizes the amplified signal and compresses the digitalized signal in accordance with a predetermined sound coding system to obtain transmitted sound data. The transmitted sound data is input to the CDMA codec 54. The CDMA codec 54 then subjects the data to spreading and orthogonal modulation. A transmitting unit 53 then subjects the orthogonal modulated signal thus obtained to a digital-analog conversion and a frequency conversion (up convert) to convert it into an RF signal. The power amplifier then amplifies the RF signal and supplies the amplified signal to the antenna 50 via the duplexer 51. As a result, the RF signal is radiated to the air as an electric wave and transmitted to the base station.

A control unit 60 consisting of a central processing unit (CPU) controls each unit, performs various mathematical operations, and processes video and text information. The control unit 60 connects not only to the CDMA codec 54 and sound codec 55 but also to a key input unit 61, a display 62, a video codec 63, and a camera (imaging device) 64. Each unit is supplied with power from a battery (not shown) under the control of the control unit 60.

The video codec 63 conforms to H.264/AVC and includes the video encoder shown in FIG. 1 and a video decoder not shown in the drawings. A video encoder codes a motion picture signal obtained using, for example, the camera 64 to generate a coded bit stream. The coded bit stream is supplied to the CDMA codec 54 under the control of the control unit 60. The coded bit stream is then transmitted to the base station via the transmitting unit 53, duplexer 51, and antenna 50. In this case, by causing the control unit 60 to process the motion picture signal obtained using the camera 64 and to supply the processed signal to the display 62, it is possible to monitor the photographed image.

If the received data is a compressed motion picture signal, the CDAM codec 54 converts the received data into a coded bit stream. The coded bit stream is input to the video decoder. The video decoder decodes the coded bit stream to generate a motion picture signal. The motion picture signal generated by the video decoder is supplied to the display 62 under the control of the control unit 60. Consequently, the display 62 shows the signal as an image.

The CPU of the control unit 60 uses software to execute a part of the processing required for the video encoder (for example, determination of a prediction mode) and a part of the processing required for the video decoder.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video encoder which encodes a video signal input in a frame unit, comprising:
a determination unit configured to determine an insertion position of a refresh macro block to generate first information indicating the insertion position of the refresh macro block;
a division unit configured to divide the frame into a plurality of slices, with reference to the first information, so as to set the refresh macro block to the starting position of the slice, and generate second information indicating that the slice composition is changed;
an intra-predictor to perform an intra prediction in the slice based on the second information to generate a prediction image signal; and
an encoding unit configured to encode the input video signal by use of the prediction image signal.

2. A video encoder which encodes a video signal input in a frame unit, comprising:
a reference frame memory to store the input video signal as a reference image signal;
a motion vector detector to detect a motion vector in a macro block unit in the reference image signal;
an inter-predictor to perform an inter prediction by use of the motion vector and reference image signal to generate an inter prediction image signal;
a determination unit configured to determine an insertion position of a refresh macro block to generate first information indicating the insertion position of the refresh macro block;
a division unit configured to divide the frame into a plurality of slices, with reference to the first information, so as to set the refresh macro block to the starting position of the slice, and generate second information indicating that a slice composition is changed;
an intra-predictor to perform an intra prediction in the slice based on the second information to generate an intra prediction image signal;
a selecting unit configured to select one prediction image signal from the intra prediction image signal and inter prediction image signal; and
an encoding unit configured to encode the input video signal by use of the prediction image signal.

3. The video encoder according to claim 2, wherein the selecting unit is configured to preferentially select the intra prediction image signal as a prediction image signal when the second information is detected.

4. The video encoder according to claim 2, wherein the selecting unit is configured to compare a degree of similarity between the intra prediction image signal and the input video signal and a degree of similarity between the inter prediction image signal and the input video signal and select one of the prediction image signals which has a higher degree of similarity when no second information is detected.

5. A video encoder which encodes a video signal input in a frame unit, comprising:
a calculation unit configured to calculate a difference between an input video signal and a prediction image signal to create a residual signal;
a discrete cosine transform(DCT)/quantization unit configured to subject the residual signal to a DCT and quantization process to create a transform coefficient signal;
an inverse cosine transform(IDCT)/inverse quantization unit configured to subject the transform coefficient signal to an inverse quantization and IDCT process to generate a decoded signal of the residual signal;
a decoding unit configured to add the decoded signal of the residual signal and the prediction image signal to generate a decoded signal of the input video signal;
a deblocking filter to filter the decoded signal of the input video signal;
a reference frame memory to store a signal filtered by the deblocking filter as a reference image signal;
a motion vector detector to detect a motion vector in the macro block unit in the reference image signal;
an inter-predictor to perform an inter prediction by use of the motion vector and reference image signal to generate an inter prediction image signal;
a determination unit configured to determine an insertion position of a refresh macro block to generate first information indicating the insertion position of the refresh macro block;
a division unit configured to divide the frame into a plurality of slices, with reference to the first information, so as to set the refresh macro block to the starting position of the slice, and generate second information indicating that a slice composition is changed;
an intra-predictor to perform an intra prediction in the slice based on the second information to generate an intra prediction image signal;
a selecting unit configured to select one prediction image signal from the intra prediction image signal and inter prediction image signal; and
an encoder to encode the transform coefficient signal.

6. The video encoder according to claim 5,
wherein the selecting unit is configured to preferentially select the intra prediction image signal as a prediction image signal when the second information is detected.

7. The video encoder according to claim 5,
wherein the selecting unit is configured to compare a degree of similarity between the intra prediction image signal and the input video signal and a degree of similarity between the inter prediction image signal and the input video signal and select one of the prediction image signals which has a higher degree of similarity when no second information is detected.
